(19) United States
(12) Patent Application Publication
(10) Pub. No.: US 2012/0239715 A1
(43) Pub. Date: Sep. 20, 2012

(54) INFORMATION PROCESSING APPARATUS WITH LOG OUTPUT FUNCTION, MOBILE TERMINAL DEVICE, AND LOG OUTPUT CONTROL METHOD

(75) Inventor: Atsushi NISHIDE, Kawasaki (JP)

(73) Assignee: FUJITSU LIMITED, Kawasaki-shi (JP)

(21) Appl. No.: 13/344,405

(22) Filed: Jan. 5, 2012

(30) Foreign Application Priority Data
Mar. 15, 2011 (JP) 2011-057267

(51) Int. Cl. G06F 17/30

(52) U.S. Cl. 707/822; 707/E17.01

(57) ABSTRACT

An information processing apparatus executing a program module under control of an operating system, the apparatus includes a log mode setting unit that sets a log mode that is an operating state for collecting information related to an operation in the information processing apparatus, a log mode control unit that, during an activation process of the operating system, loads a log output module that is a program module for outputting, as a log, information related to an access request between the operating system and a hardware resource when the access request is generated, if the log mode is set in the information processing apparatus when the operating system is activated and a log collecting unit that collects the information related to the access request as the log according to the log output module.

### CROSS-REFERENCE TO RELATED APPLICATION

This application is based upon and claims the benefit of priority of the prior Japanese Patent Application No. 2011-57267, filed on Mar. 15, 2011, the entire contents of which are incorporated herein by reference.

### FIELD

The present invention relates to an information processor apparatus having a log output function.

### BACKGROUND

Log output devices that output logs are well known.

For example, log output devices output logs in a system by activating an application program including a log output command (see, for example, Japanese Laid-open Patent Publication No. 2009-110156). The log output device detects system state information for judging the state of the system, and then, based on that system state information, determines a reference level that indicates whether or not the information is subject to outputting as a log. The log output device determines whether to output the information as logs based on the reference level.

The reference level is changed according to the system state by the log output device. Different reference levels can be set for when the system state is normal or abnormal since the reference level is changed. More appropriate logs can be outputted since different reference levels are set according to whether the system state is normal or abnormal.

Furthermore, a log output device is known, for example, that detects a request from an operating system to access a disk drive, and accumulates a history of the disk drive operating states as log information when necessary (see, for example, Japanese Laid-open Patent Publication No. 2010-157266).

### SUMMARY

According to an aspect of the invention, an information processing apparatus, executing a program module under control of an operating system, includes a log mode setting unit that sets a log mode that is an operating state for collecting information related to an operation in the information processing apparatus, a log mode control unit that, during an activation process of the operating system, loads a log output module that is a program module for outputting, as a log, information related to an access request between the operating system and a hardware resource when the access request is generated, if the log mode is set in the information processing apparatus when the operating system is activated and a log collecting unit that collects the information related to the access request as the log according to the log output module.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an embodiment of a mobile terminal.

FIG. 2 is a functional block diagram illustrating an embodiment of a mobile terminal.

FIG. 3 is a flow chart illustrating an embodiment of mobile terminal operations.

FIG. 4 is a flow chart illustrating an embodiment of mobile terminal activation processing.

FIG. 5 is a flow chart illustrating an embodiment of mobile terminal activation processing.

FIG. 6 is a flow chart illustrating an embodiment of mobile terminal operations.

FIG. 7 is a flow chart illustrating an embodiment of mobile terminal operations.

FIG. 8 is a functional block diagram illustrating an embodiment of a mobile terminal.

FIG. 9 is a flow chart of an embodiment of mobile terminal activation processing.

### DETAILED DESCRIPTION OF THE EMBODIMENTS

In Japanese Laid-open Patent Publication No. 2009-110156, whether a log is to be actually outputted is judged by comparing the log to be acquired and a certain reference level upon receiving a log output command. The amount of information of the log to be outputted can be adjusted by the judgment of whether or not to output the log.

However, log output commands are included in an application program. Therefore, the capacity of the application program increases as the number of log output commands increases.

The capacity of the application program affects the consumption rate of the auxiliary storage medium that stores the application program, as well as the capacity of the main storage medium consumed when executing the application program. Further, the capacity of the application program affects the time needed for loading from the auxiliary storage medium to the main storage medium. As a result, products are often shipped from factories in a state where the number of log output commands in a program module is reduced to meet the market demand for the effective use of hardware resources such as auxiliary and main storage media. As a result, when a defect occurs in the product shipped from the factory, enough information to understand the cause of the defect cannot be acquired with only the logs outputted according to the log output commands included in the application program. Effective solutions cannot be studied since not enough information can be acquired.

Moreover, a computing load is generated due to conducting comparisons when the log to be acquired according to the log output command and a certain reference level are compared. As a result of this computing load, the market demand for the effective use of hardware resources cannot be met and the appeal of such products is reduced.

In Japanese Laid-open Patent Publication No. 2010-157266, a monitoring driver may be provided for monitoring commands to be issued from an HDD driver to the HDD based on an access request from the operating system to the HDD, and for monitoring the responses to those commands. In this case, information other than log information can be acquired due to the log output commands included in the application program.

However, since commands such as access requests to the HDD are generated frequently, constantly monitoring HDD access requests and responses to the commands of a product in the operational phase generates a computing load in the device since computing is conducted to monitor each occurrence of an access request. As a result of this computing load, the market demand for the effective use of hardware resources cannot be met and the appeal of such products is reduced.

According to the embodiments disclosed herein, collecting logs that contribute to solving defects, while using hardware resources effectively can be achieved.

The following description is explained with reference to the drawings.

In all of the drawings describing the embodiments, the same reference numerals will be used for parts with the same functions and repetitive explanations will be omitted.

### First Embodiment

### Mobile Terminal

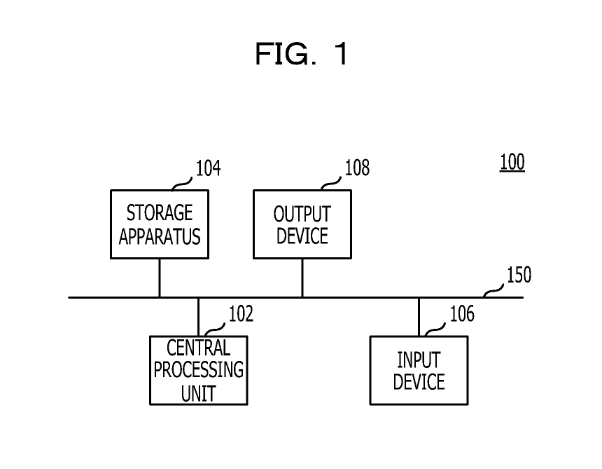

FIG. 1 illustrates an embodiment of a mobile terminal 100. A hardware configuration is mainly illustrated in FIG. 1.

The mobile terminal 100 includes a central processing unit (CPU) 102, a storage apparatus 104, an input device 106, and an output device 108. The devices are interconnected by a bus 150. The present embodiment will be described using the mobile terminal 100 as an example. The present embodiment is not limited to a mobile terminal. Other devices and systems that have a log output function may also be applicable. In general, the present embodiment may be applicable to an information processor apparatus. For example, the first embodiment may also be applicable to a personal digital assistant (PDA) or other apparatus.

The central processing unit 102 controls the storage apparatus 104, the input device 106, and the output device 108. The central processing unit 102 functions according to programs stored in the storage apparatus 104 to conduct certain processes.

The storage apparatus 104 includes various applications, various services, an operating system (OS), and various drivers. For example, the storage apparatus 104 may be an external storage device for storing data and programs in a computer. For example, the storage apparatus 104 may be a hard disk, a flexible disk, a magneto-optical disk (MO), a recordable compact disk (CD-R), or an electromagnetic tape.

An application is software that has a function of implementing work conducted by a user on the mobile terminal 100. For example, applications may include word processors, tabulation software, database management systems (DBMS), media players, and the like.

Information from the operating system is converted to a service which then notifies an application.

The operating system is software that provides a hardware abstraction interface for application software in the mobile terminal 100.

The various drivers are software for providing interfaces between device levels for the central processing unit 102 to function as an operating system 222.

The input device 106 is constituted, for example, by a keyboard or a touch panel and the like, and is a device for inputting instructions to the corresponding mobile terminal 100 and for inputting data. The instructions include instructions for the operating system and instructions for applications.

The output device 108 is constituted, for example, by a display for displaying processing states and processing results from the corresponding mobile terminal 100. The processing states and results include items from the operating system and from applications. Types of displays include liquid crystal displays (LCD), cathode ray tube (CRT) displays, plasma display panels (PDP), organic electro-luminescence (EL) displays, and the like.

<Mobile Terminal Functions>

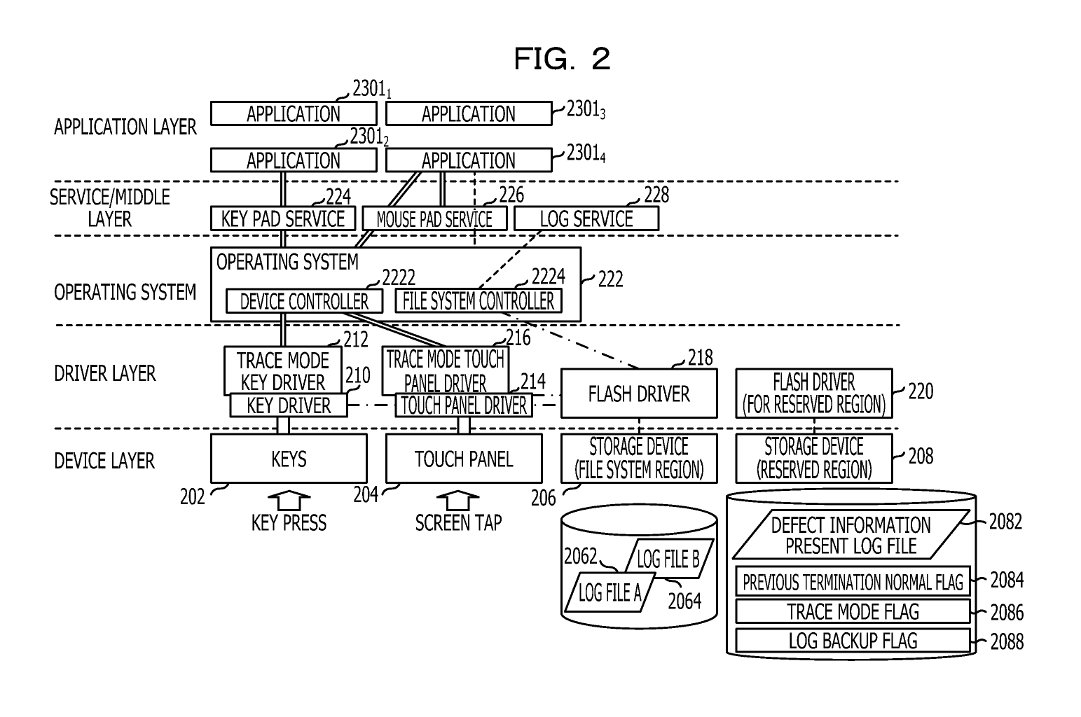

FIG. 2 illustrates an embodiment of the mobile terminal 100. FIG. 2 mainly illustrates a software configuration.

The mobile terminal 100 illustrated in FIG. 2 is depicted by a device layer, a driver layer, the operating system, a service/middle layer, and an application layer.

<Device Layer>

The device layer includes keys 202. The keys 202 are included in the input device 108. The keys 202 input signals corresponding to keys pressed by a user to a key driver 210. The signals may include information indicating the pressed keys.

The device layer includes a touch panel 204. The touch panel 204 is included in the input device 108. The touch panel 204 inputs signals corresponding to a display to a touch panel driver 214 when a user touches the display on the touch panel. The signals may include information indicating an instruction position on the touch panel.

The device layer includes a storage device 206. The storage device 206 is included in the storage apparatus 104. The storage device 206 may be implemented by a certain storage region of the storage apparatus 104. The storage device 206 may also be a file system region. The storage device 206 includes one or more log files. The example in FIG. 2 illustrates two log files, namely log file A 2062 and log file B 2064. The storage device 206 is a region that can be read or written to by an OS file system. The storage device 206 may be initialized when the mobile terminal 100 is set to a factory default state.

The device layer includes a storage device 208. The storage device 208 is included in the storage apparatus 104. The storage device 208 may be implemented by a certain storage region of the storage apparatus 104. The storage device 208 may be a reserved region. The storage device 208 includes one or more log files and one or more flags. The example illustrated in FIG. 2 illustrates a defect information present log file 2082 that stores logs including defect information, a previous termination normal flag 2084 that indicates whether a previous termination was terminated normally, a trace mode flag 2086 that indicates whether a log mode for acquiring a log has been set, and a log backup flag 2088 that indicates whether a log backup is to be conducted. The reserved region is a region in which reading and writing from OS file systems cannot be conducted. The storage device 208 may not be initialized even when the mobile terminal 100 is set to the factory default state. Specifically, the various types of information according to the present embodiment stored in the storage device 208 are not subject to initialization when performing a recovery to return to an initial state similar to the state when shipped from the factory. Herein, a log mode represents the acquisition of information related to operations of the mobile terminal 100 as a history. The information related to operations may be information originating from operation of a mobile terminal by a user operation. Moreover, the information related to operations may be information originating from a request from another device. The request from another device may include incoming calls to the mobile terminal 100. Furthermore, the information related to operations may be information originating from an operation automatically conducted by the mobile terminal 100. Operations automatically conducted by the mobile terminal 100 may include updates of software installed in the mobile terminal 100 and the like. When such operations are conducted, an access request between the OS and the hardware resources is conducted. As a result, the information related to operations may also be information related to access requests between the OS and the hardware resources.

<Driver Layer>

The driver layer includes the key driver 210. The key driver 210 detects an interruption from the device layer and notifies the OS 222. In short, the key driver 210 may be a program module for causing the central processing unit 102 to conduct a process to report information indicating codes of the pressed keys to the OS 222, when the keys 202 are pressed.

The driver layer includes a trace mode key driver 212. The trace mode key driver 212 detects an interruption from the device layer and further outputs the interruption from the device layer to a log while also reporting the interruption to the OS 222. Specifically, the trace mode key driver 212 may include the key driver 210 functions and further may also be a program module for causing the central processing unit 102 to output the interruption from the device layer to a log. Specifically, the trace mode key driver 212 reports information indicating the codes of pressed keys to the OS 222 when the keys 202 are pressed. Moreover, the trace mode key driver 212 outputs the information indicating the codes of the pressed keys to a flash driver 218. The trace mode key driver 212 may also output information indicating that the keys have been pressed to the flash driver 218. In this case, the trace mode key driver 212 is loaded in place of the key driver 210.

The trace mode key driver 212 may also have a function to output interruptions from the device layer to a log. Specifically, the trace mode key driver 212 may be a program module for causing the central processing unit 102 to output the interruptions from the device layer to a log. In this case, the trace mode key driver 212 may be called a “sub-key driver.” The trace mode key driver 212 outputs the interruptions from the device layer to the log according to operations by the key driver 210 as well. Specifically, the key driver 210 reports information indicating the codes of pressed keys to the OS 222 when the keys 202 are pressed. The trace mode key driver 212 outputs the information indicating the codes of the pressed keys to the flash driver 218 in response to the reporting of the information indicating the codes of the pressed keys by the key driver 210. The trace mode key driver 212 may be configured to output the information indicating the codes of the pressed keys to the flash driver 218 in response to the reporting of the information indicating the codes of the pressed keys by the key driver 210.

The following description mainly describes a case where the trace mode key driver 212 has a function to output the interruptions from the device layer to a log as an example.

<Activation of Trace Mode Key Driver (1)>

The trace mode key driver 212 has a function to output interruptions from the device layer to a log. In this case, the trace mode key driver 212 may determine whether to conduct loading by the key driver 210 upon activation of the OS 222. Specifically, upon the activation of a boot loader, the previous termination normal flag 2084 stored in the storage device 208 is checked. If the previous termination normal flag 2084 is not ON, namely the previous termination was not terminated normally, the trace mode flag 2086 and the log backup flag 2088 are turned ON. Either one of the trace mode flag 2086 or the log backup flag 2088 may also be turned ON when the previous termination is not terminated normally. Further, the previous termination normal flag 2084 is turned OFF.

The various device drivers are initialized when the OS 222 is activated. The key driver 210 is also initialized during this initialization. When the key driver 210 is initialized, the key driver 210 determines whether the trace mode flag 2086 is ON. If the trace mode flag 2086 is determined to be ON, the trace mode key driver 212 may be loaded.

<Activation of Trace Mode Key Driver (2)>

The trace mode key driver 212 has a function to output interruptions from the device layer to a log. In this case, the trace mode key driver 212 may determine whether to conduct unloading by the trace mode key driver 212 upon activation of the OS 222. Specifically, upon the activation of the boot loader, the previous termination normal flag 2084 stored in the storage device 208 is checked. If the previous termination normal flag 2084 is not ON, namely the previous termination was not terminated normally, the trace mode flag 2086 and the log backup flag 2088 are turned ON. Either one of the trace mode flag 2086 or the log backup flag 2088 may also be turned ON when the previous termination is not terminated normally. Further, the previous termination normal flag 2084 is turned OFF.

The various device drivers are initialized when the OS 222 is activated. The key driver 210 and the trace mode key driver 212 are both initialized during this initialization. Whether the trace mode key driver 212 is loaded and whether the trace mode flag 2086 is OFF is determined upon the initialization of the trace mode key driver 212. If the trace mode flag 2086 is determined to not be OFF, that is, determined to be ON, the trace mode key driver 212 is not unloaded. In short, the activation of the trace mode key driver 212 is successful. If the trace mode flag 2086 is determined to be OFF, the trace mode key driver 212 is unloaded.

By determining whether to activate the trace mode key driver 212 by the key driver 210 or by the trace mode key driver 212, the trace mode key driver 212 can be activated without performing changes in the OS.

The driver layer includes the touch panel driver 214. The touch panel driver 214 detects an interruption from the device layer and notifies the OS 222. Specifically, the touch panel driver 214 may be a program module for causing the central processing unit 102 to conduct a process for reporting information indicating coordinates of a touched position to the OS 222 when the touch panel 204 is touched.

The driver layer includes a trace mode touch panel driver 216. The trace mode touch panel driver 216 detects an interruption from the device layer and outputs the interruption from the device layer to a log while also reporting the interruption to the OS 222. Specifically, the trace mode touch panel driver 216 may include the touch panel driver 214 functions and further may also be a program module for causing the central processing unit 102 to output the interruption from the device layer to a log. Specifically, the trace mode touch panel driver 216 reports information indicating the coordinates of the touched position to the OS 222. Moreover, the trace mode touch panel driver 216 outputs the information indicating the coordinates of the touched position to the flash driver 218. The trace mode touch panel driver 216 may also be configured to output the information indicating the coordinates of the touched position to the flash driver 218. In this case, the trace mode touch panel driver 216 is loaded in place of the touch panel driver 214.

The trace mode touch panel driver 216 may also have a function to output interruptions from the device layer to a log. Specifically, the trace mode touch panel driver 216 may be a program module for causing the central processing unit 102 to conduct a process to output the interruption from the device layer to a log. In this case, the trace mode touch panel driver 216 may be called a “sub-touch panel driver.” The trace mode touch panel driver 216 outputs the interruptions from the device layer to the log according to operations by the touch panel driver 214 as well. Specifically, the touch panel driver 214 reports the information indicating the coordinates of the touched position to the OS 222 when the touch panel 204 is touched. The trace mode touch panel driver 216 outputs the information indicating the coordinates of the touched position to the flash driver 218 in response to the reporting of the information indicating the coordinates of the touched position by the touch panel driver 214. The trace mode touch panel driver 216 may also be configured to output the information indicating the coordinates of the touched position to the flash driver 218 in response to the reporting of the information indicating the coordinates of the touched position by the touch panel driver 214.

The following description mainly describes a case where the trace mode touch panel driver 216 has a function to output the interruptions from the device layer to a log as an example.

<Trace Mode Touch Panel Driver Activation (1)>

The trace mode touch panel driver 216 has a function to output interruptions from the device layer to a log. In this case, the trace mode touch panel driver 216 may determine whether to conduct loading by the touch panel driver 214 upon activation of the OS 222. Specifically, upon the activation of the boot loader, the previous termination normal flag 2084 stored in the storage device 208 is checked. If the previous termination normal flag 2084 is not ON, namely the previous termination was not terminated normally, the trace mode flag 2086 and the log backup flag 2088 are turned ON. Either one of the trace mode flag 2086 or the log backup flag 2088 may be turned ON when the previous termination is not normal. Further, the previous termination normal flag 2084 is turned OFF.

The various device drivers are initialized when the OS 222 is activated. The touch panel driver 214 is also initialized during this initialization. When the touch panel driver 214 is initialized, the touch panel driver 214 determines whether the trace mode flag 2086 is ON. If the trace mode flag 2086 is determined to be ON, the trace mode touch panel driver 216 may be loaded.

<Trace Mode Touch Panel Driver Activation (2)>

The trace mode touch panel driver 216 has a function to output interruptions from the device layer to a log. In this case, the trace mode touch panel driver 216 may determine whether to conduct unloading by the trace mode touch panel driver 216 upon activation of the OS 222. Specifically, upon the activation of the boot loader, the previous termination normal flag 2084 stored in the storage device 208 is checked. If the previous termination normal flag 2084 is not ON, namely the previous termination was not terminated normally, the trace mode flag 2086 and the log backup flag 2088 are turned ON. Either one of the trace mode flag 2086 or the log backup flag 2088 may be turned ON when the previous termination is not terminated normally. Further, the previous termination normal flag 2084 is turned OFF.

The various device drivers are initialized when the OS 222 is activated. The touch panel driver 214 and the trace mode touch panel driver 216 are both initialized during this initialization. Whether the trace mode touch panel driver 216 is loaded and whether the trace mode flag 2086 is OFF is determined upon the initialization of the trace mode touch panel driver 216. If the trace mode flag 2086 is determined to not be OFF, that is, determined to be ON, the trace mode touch panel driver 216 is not unloaded. In short, the activation of the trace mode touch panel driver 216 is successful. If the trace mode flag 2086 is determined to be OFF, the trace mode touch panel driver 216 is unloaded.

Since whether to activate the trace mode touch panel driver 216 is determined by the touch panel driver 214 or the trace mode touch panel driver 216, causing the trace mode touch panel driver 216 to be activated can be conducted without additional changes to the existing installation of the OS.

The driver layer includes the flash driver 218. The flash driver 218 writes in the storage device 206 in response to a request to write from the OS 222. Specifically, the flash driver 218 writes, to the storage device 206, a log to be inputted by a file system controller 2224 of the OS 222. Moreover, the flash driver 218 writes in the storage device 206 in response to write requests from the trace mode key driver 212 and the trace mode touch panel driver 216. Specifically, the flash driver 218 writes, to the storage device 206, a log to be inputted by the trace mode key driver 212 and the trace mode touch panel driver 216. Moreover, the flash driver 218 inputs a defect log to a flash driver 220 when the file system controller 2224 reports that the amount of information stored in the log file A 2062 and the log file B 2064 exceeds capacity and when the defect log is included in the stored information. The flash driver 220 stores, in the defect information present log file 2082, the defect log inputted by the flash driver 218.

The driver layer includes the flash driver (for reserved region) 220. The flash driver 220 writes a log including defect information to be inputted from the flash driver 218 according to a request from the OS 222, in the defect information present log file 2082 in the storage device 208. Specifically, the flash driver 220 writes the defect information present log file 2082 into the storage device 208. Furthermore, the flash driver 220 sets the previous termination flag 2082, the trace mode flag 2086, and the log backup flag 2088 to ON or OFF.

<Operating System>

The operating system 222 manages the entire mobile terminal 100 through the execution of functions commonly used by the applications, such as an input function conducted by the input device 106, an output function conducted by the output device 108, and a file system control function conducted by the storage apparatus 104.

The operating system 222 includes a device controller 2222. The device controller 2222 reports information indicating codes of pressed keys from the key driver 210, and information indicating coordinates of touched positions from the touch panel driver 214, to the service/middle layer. The device controller 2222 further reports information indicating codes of pressed keys from the key driver 210, and information indicating coordinates of touched positions from the touch panel driver 214, to the application layer.

Moreover, the trace mode key driver 212 has functions of the key driver 210. When the trace mode touch panel driver 216 has touch panel driver 214 functions, the device controller 2222 reports information indicating codes of pressed keys to be inputted by the trace mode key driver 212, and information indicating coordinates of touched positions to be inputted by the trace mode touch panel driver 216, to the service/middle layer. The device controller 2222 also reports information indicating the codes of pressed keys to be inputted by the trace mode key driver 212, and information indicating the coordinates of touched positions to be inputted by the trace mode touch panel driver 216, to the application layer.

The operating system 222 includes the file system controller 2224. The file system controller 2224 reports logs to be reported by the application layer and the service/middle layer to the flash driver 218.

Further, the file system controller 2224 controls information to be stored in the storage device 206 and the storage device 208. For example, the file system controller 2224 determines whether the information to be stored in the log file A 2062 or the log file B 2064 exceeds the capacity of the log file A 2062 or the log file B 2064. Moreover, when it is determined that the capacity is exceeded, the file system controller 2224 determines whether a defect log is included in the stored information. When it is determined that the defect log is included in the stored information, the file system controller 2224 further notifies the flash driver 218 that the defect log is included in the stored information and that the log file A 2062 or log file B 2064 capacity is exceeded.

<Service/Middle Layer>

The service/middle layer includes a keypad service 224. The keypad service 224 converts information indicating the codes of pressed keys to be reported by the OS 222, to a service. The keypad service 224 reports the information indicating the codes of pressed keys that has been converted for the service, to the application layer.

The service/middle layer includes a mouse pad service 226. The mouse pad service 226 converts information indicating the coordinates of touched positions to be reported by the OS 222, to a service. The mouse pad service 226 reports the information indicating the coordinates of touched positions converted to the service, to the application layer. For example, when the position corresponds to an icon indicating “activate mail” based on the coordinates of the touched position, the information is reported to a mailer. Moreover, for example, when the position corresponds to an icon indicating “activate internet” based on the coordinates of the touched position, the information is reported to a browser.

The service/middle layer includes a log service 228. The log service 228 collects logs of applications used by the user. The log service 228 reports the logs of the applications used by the user to file system controller 2224.

<Application Layer>

The application layer includes one or more applications 230ₙ (where “n” is an integer greater than 0). FIG. 2 illustrates an example where “n” equals 4. “n” may also be 1 to 3 or a number greater than 4. The application 230ₙ acquires information indicating a service from the service/middle layer. The application 230ₙ acquires the information indicating the codes of pressed keys, and the information indicating the coordinates of touched positions, from the OS 222. The application 230ₙ executes certain processes according to the acquired information.

<Mobile Terminal Operations (1)>

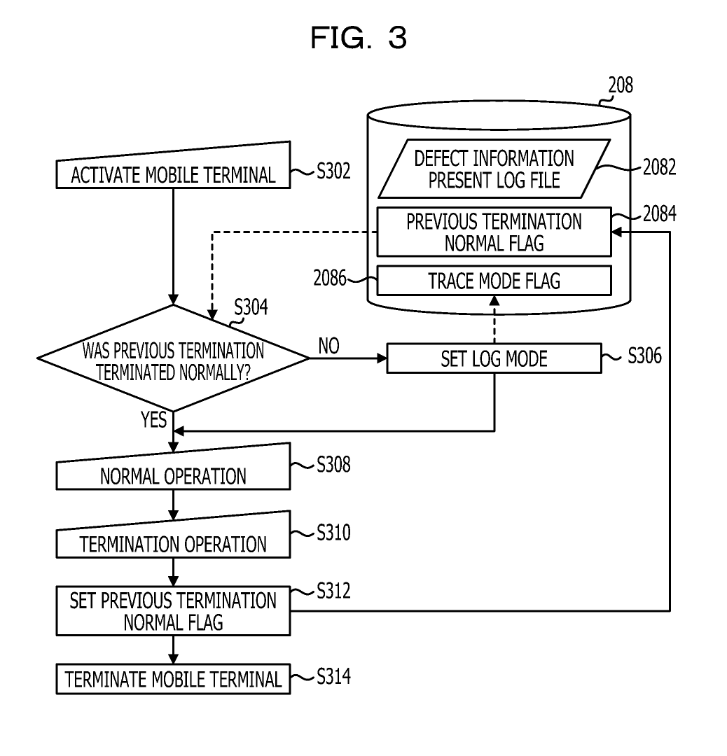

FIG. 3 illustrates an embodiment of processing by the mobile terminal 100.

The flow chart in FIG. 3 describes determining whether to set a log mode to acquire a log in the mobile terminal 100. For example, when the mobile terminal 100 is activated, a determination is made as to whether to set the log mode based on whether a previous termination was terminated normally or not. Specifically, it is determined that the log mode is set when the previous termination is not terminated normally. This is because, if the previous termination is not terminated normally, detailed log information is desirably acquired.

The mobile terminal 100 is activated (step S302). Specifically, the mobile terminal 100 is activated due to a certain operation conducted by the user.

The mobile terminal 100 determines whether the previous termination was terminated normally or not (step S304). Specifically, at least one of the key driver 210 and the trace mode key driver 212 refers to the previous termination normal flag 2084 stored in the storage device 208 to determine whether the previous termination was terminated normally or not.

If it is determined that the previous termination was not terminated normally (step S304: NO), the mobile terminal 100 sets the log mode (step S306). Specifically, when it is determined that the previous termination was not terminated normally, the key driver 210 or the trace mode key driver 212 determines to set the log mode.

Specifically, when it is determined that the previous termination was not terminated normally, the key driver 210 determines to load the trace mode key driver 212. The device controller 2222 loads the trace mode key driver 212 according to the determination by the key driver 210. The setting of the log mode is conducted based on the loading of the trace mode key driver 212. Specifically, when it is determined that the previous termination was not terminated normally at the previous termination, the trace mode key driver 212 determines to not unload the trace mode key driver 212. The device controller 2222 does not unload the trace mode key driver 212 according to the determination by the trace mode key driver 212. The setting of the log mode is conducted based on the trace mode key driver 212 remaining loaded.

When it is determined that the previous termination was terminated normally in step S304 upon the previous termination (step S304: YES), or when the setting of the log mode is conducted according to step S306, the mobile terminal 100 can be operated by the user (step S308).

When the log mode is set, information related to access requests between the operating system and the hardware resources in response to a user operation is collected as a log.

The user conducts an operation to terminate the mobile terminal 100 (step S310). The mobile terminal 100 is terminated according to a certain operation by the user.

When the mobile terminal 100 is terminated normally, the mobile terminal 100 makes a setting to indicate that the termination was conducted normally (step S312). Specifically, when unloading by the various drivers is conducted, the flash driver 220 sets the previous termination normal flag 2084 to be stored in the storage device 208 to ON. Conversely, if the mobile terminal 100 was not terminated normally, the mobile terminal 100 conducts a setting to indicate that the termination was not conducted normally. Specifically, when unloading by the various drivers is conducted, the flash driver 220 sets the previous termination normal flag 2084 to be stored in the storage device 208 to OFF. For example, when a defect occurs in the mobile terminal 100 and operations are disabled due to the defect, or when the power is forcefully turned off, or when the mobile terminal 100 is recovered due to replacing the battery or an automatic reboot, the previous termination normal flag 2084 is set to OFF.

The power of the mobile terminal 100 is turned off (step S314).

<Mobile Terminal Activation Processing Details>

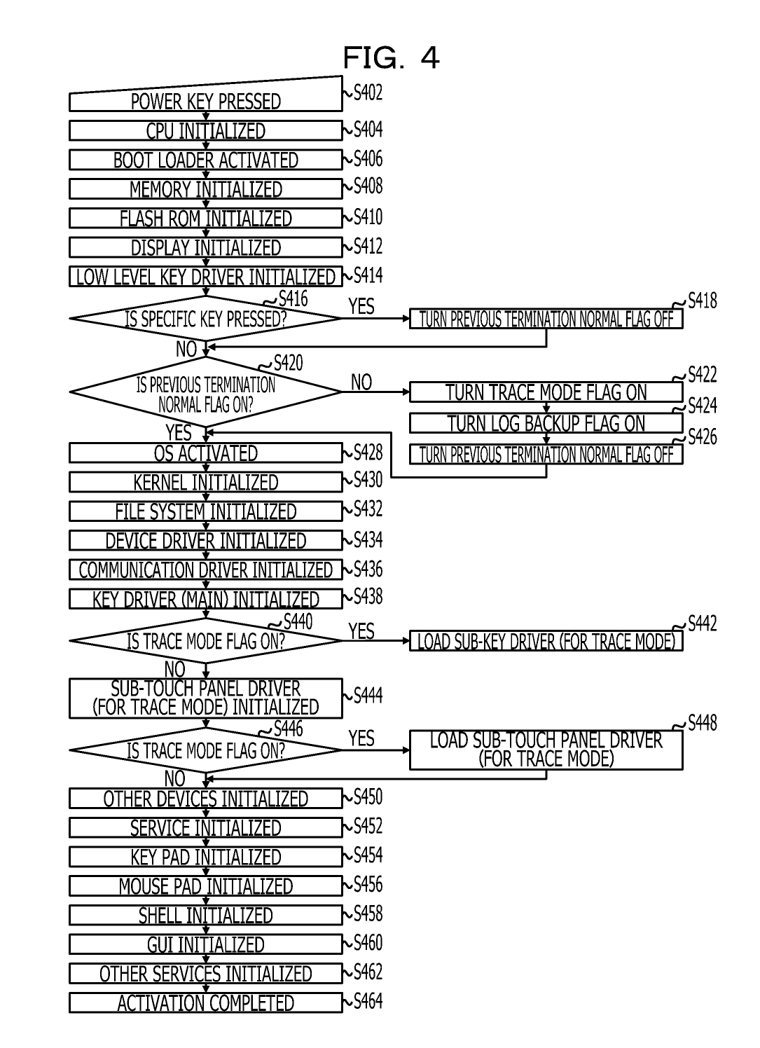

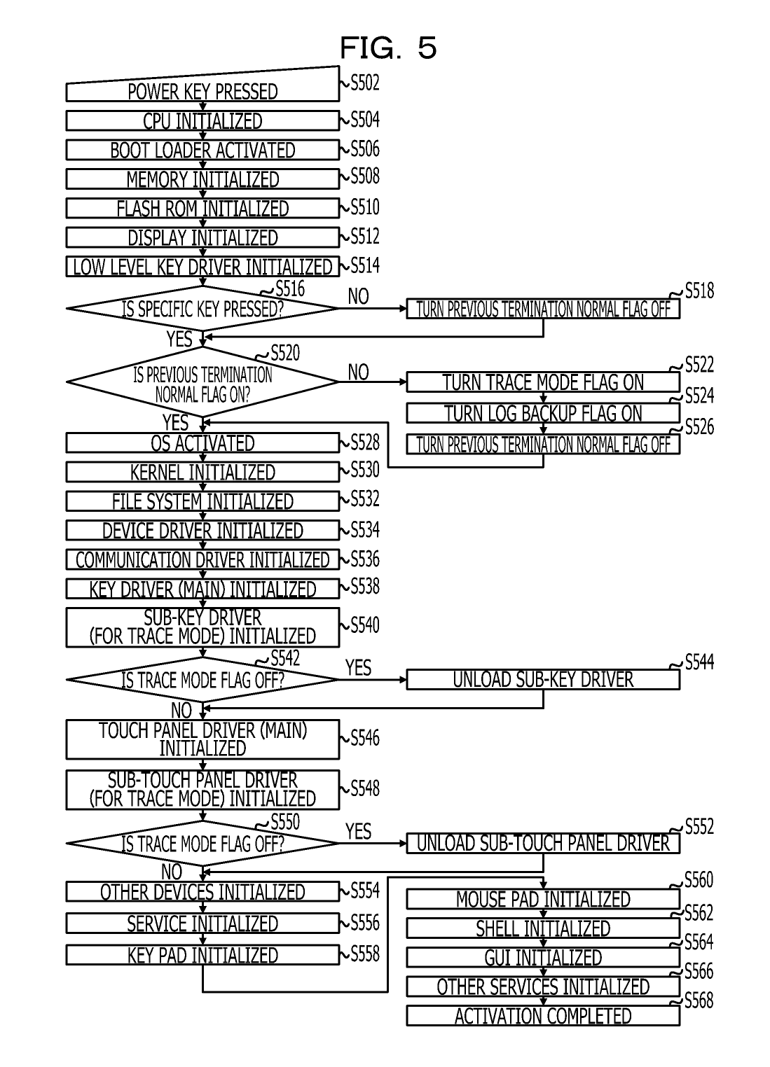

FIGS. 4 and 5 are flow charts illustrating details of the activation processing of the mobile terminal 100.

<Mobile Terminal Activation Processing (1)>

FIG. 4 illustrates an example in which loading of the trace mode key driver 212 is determined by the key driver 210, and loading of the trace mode touch panel driver 216 is determined by the touch panel driver 214.

The power key of the mobile terminal 100 is pressed (step S402).

The mobile terminal 100 initializes the CPU 102 (step S404).

The mobile terminal 100 activates the boot loader (step S406).

The mobile terminal 100 initializes the memory (step S408). Specifically, the boot loader initializes the memory.

The mobile terminal 100 initializes the flash ROM (step S410). Specifically, the boot loader initializes the flash ROM.

The mobile terminal 100 initializes the display (step S412). Specifically, the boot loader initializes the display.

The mobile terminal 100 initializes a low level key driver (step S414). Specifically, the boot loader initializes the low level key driver. The low level key driver may be a part of the key driver 210.

The mobile terminal 100 determines whether a specific key was pressed (step S416). Specifically, the low level key driver determines whether a specific key among the keys 202 was pressed. The boot loader may also determine whether a specific key of the keys 202 was pressed. If the user wants to set the log mode, the user can manually set the log mode by pressing the specific key upon activation of the boot loader.

If the specific key is pressed (step S416: YES), the mobile terminal 100 turns the previous termination normal flag 2084 OFF (step S418). Specifically, if it is determined that the specific key of the keys 202 is pressed, the low level key driver instructs the flash driver 220 to turn the previous termination normal flag 2084 of the storage device 208 OFF. If it is determined that the specific key of the keys 202 is pressed, the boot loader may also instruct the flash driver 220 to turn the previous termination normal flag 2084 of the storage device 208 OFF. The flash driver 220 turns the previous termination normal flag 2084 of the storage device 208 OFF according to the instruction from the low level key driver.

If it is determined that the specific key is not pressed in step S416 (step S416: NO), or when the previous termination normal flag 2084 is turned OFF in step S418, the mobile terminal 100 determines whether the previous termination normal flag 2084 is ON (step S420). Specifically, the low level key driver determines whether the previous termination normal flag 2084 is ON. Whether the previous termination normal flag 2084 is ON or not may also be determined by the boot loader.

When it is determined that the previous termination normal flag 2084 is not ON (step S420: NO), the mobile terminal 100 turns the trace mode flag 2086 ON (step S422). Specifically, the low level key driver turns the trace mode flag 2086 ON. In this case, the low level key driver instructs the flash driver 220 to turn the trace mode flag 2086 ON. The trace mode flag 2086 may also be turned ON by the boot loader. In this case, the boot loader instructs the flash driver 220 to turn the trace mode flag 2086 ON. The flash driver 220 turns the trace mode flag 2086 ON according to the instruction from the low level key driver.

Moreover, the mobile terminal 100 turns the log backup flag 2088 ON (step S424). Specifically, the low level key driver turns the log backup flag 2088 ON. The low level key driver instructs the flash driver 220 to turn the log backup flag 2088 ON. The log backup flag 2088 may also be turned ON by the boot loader. In this case, the boot loader instructs the flash driver 220 to turn the log backup flag 2088 ON. The flash driver 220 turns the log backup flag 2088 ON according to the instruction from the low level key driver.

Additionally, the mobile terminal 100 turns the previous termination normal flag 2084 OFF (step S426). Specifically, the low level key driver turns the previous termination normal flag 2084 OFF. The low level key driver instructs the flash driver 220 to turn the previous termination normal flag 2084 OFF. The previous termination normal flag 2084 may also be turned OFF by the boot loader. In this case, the boot loader instructs the flash driver 220 to turn the previous termination normal flag 2084 OFF. The flash driver 220 turns the previous termination normal flag 2084 OFF according to the instruction from the low level key driver.

When the previous termination normal flag 2084 is determined to be ON (step S420: YES), or when the previous termination normal flag 2084 is turned OFF in step S426, the mobile terminal 100 activates the OS (step S428).

A kernel is initialized (step S430). Specifically, the device controller 2222 of the OS 222 initializes the kernel.

The file system is initialized (step S432). Specifically, the device controller 2222 of the OS 222 initializes the file system.

A device driver is initialized (step S434). Specifically, the device controller 2222 of the OS 222 initializes the device driver.

A communication driver is initialized (step S436). Specifically, the device controller 2222 of the OS 222 initializes the communication driver.

The key driver 210 is initialized (step S438). Specifically, the device controller 2222 of the OS 222 initializes the key driver 210.

The mobile terminal 100 determines whether the trace mode flag 2086 is ON (step S440). Specifically, the key driver 210 determines whether the trace mode flag 2086 is ON.

When the trace mode flag 2086 is determined to be ON (step S440: YES), the mobile terminal 100 loads a sub-key driver (step S442). Specifically, the device controller 2222 loads the trace mode key driver 212.

When it is determined that the trace mode flag 2086 is not ON (step S440: NO), or when the sub-key driver is loaded in step S442, the mobile terminal 100 initializes the touch panel driver 214 (step S444). Specifically, the device controller 2222 initializes the touch panel driver 214.

The mobile terminal 100 determines whether the trace mode flag 2086 is ON (step S446). Specifically, the touch panel driver 214 determines whether the trace mode flag 2086 is ON.

When the trace mode flag 2086 is determined to be ON (step S446: YES), the mobile terminal 100 loads a sub-touch panel driver (step S448).

When it is determined that the trace mode flag 2086 is not set to ON (step S446: NO), or when the sub-touch panel driver is loaded in step S448, other devices are initialized (step S450). Specifically, the device controller 2222 of the OS 222 initializes the other devices.

The mobile terminal 100 initializes a service (step S452).

The key pad is initialized (step S454).

The mouse pad is initialized (step S456).

A shell is initialized (step S458).

A GUI is initialized (step S460).

Other services are initialized (step S462).

The activation processing is completed (step S464).

<Mobile Terminal Activation Processing (2)>

FIG. 5 illustrates an example of the trace mode key driver 212 determining whether the trace mode key driver 212 is unloaded, and further, the trace mode touch panel driver 216 determining whether the trace mode touch panel driver 216 is unloaded.

The steps S502 to S538 in the flow chart illustrated in FIG. 5 indicate the same processing as steps S402 to S438 in the flow chart illustrated in FIG. 4, and thus a description thereof will be omitted.

The mobile terminal 100 initializes the sub-key driver (step S540). Specifically, the device controller 2222 initializes the sub-key driver.

The mobile terminal 100 determines whether the trace mode flag 2086 is OFF (step S542). Specifically, the trace mode key driver 212 determines whether the trace mode flag 2086 is OFF.

When it is determined that the trace mode flag 2086 is OFF (step S542: YES), the mobile terminal 100 unloads the sub-key driver (step S544). Specifically, the device controller 2222 unloads the trace mode key driver 212.

When it is not determined that the trace mode flag is OFF in step S542 (step S542: NO), or when the sub-key driver is unloaded in step S544, the mobile terminal 100 initializes the touch panel driver 214 (step S546). Specifically, the device controller 2222 initializes the touch panel driver 214.

The mobile terminal 100 initializes the sub-touch panel driver (step S548). Specifically, the device controller 2222 initializes the trace mode touch panel driver 216.

The mobile terminal 100 determines whether the trace mode flag is OFF (step S550). Specifically, the trace mode touch panel driver 216 determines whether the trace mode flag is OFF.

When it is determined that the trace mode flag is OFF (step S550: YES), the mobile terminal 100 unloads the sub-touch panel driver (step S552). Specifically, the device controller 2222 unloads the trace mode touch panel driver 216.

When it is determined that the trace mode flag 2086 is OFF in step S550 (step S550: NO), or when the sub-touch panel driver is unloaded in step S552, the mobile terminal 100 initializes the other devices (step S554).

The steps S556 to S568 are the same as steps S452 to S464 of FIG. 4 and description thereof will be omitted.

<Mobile Terminal Operations (2)>

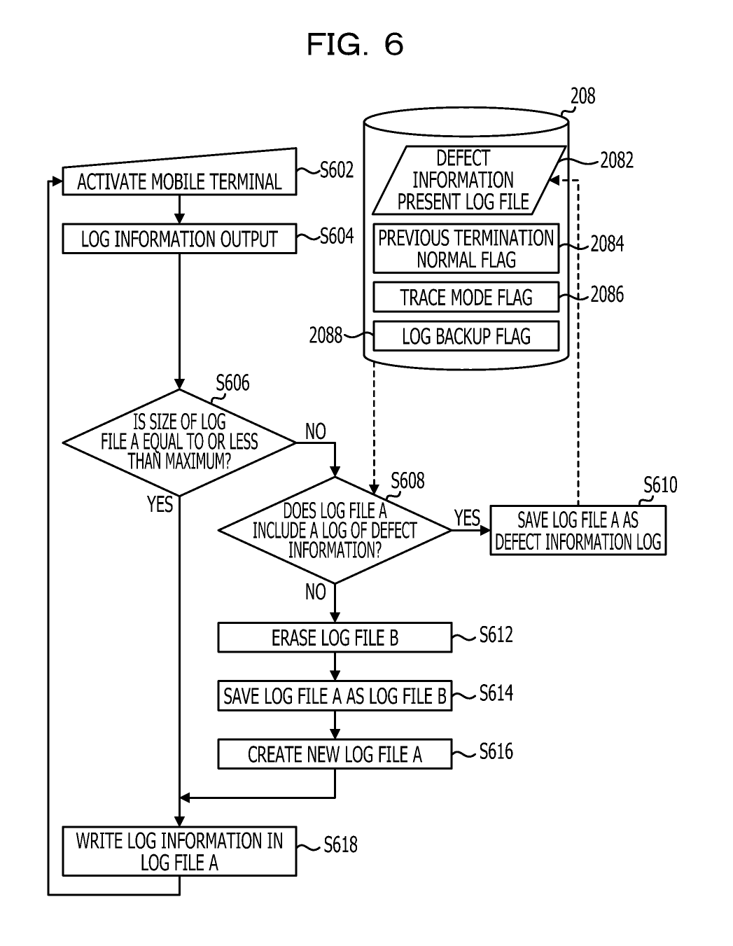

FIG. 6 illustrates an embodiment of processing by the mobile terminal 100.

The flow chart illustrated in FIG. 6 describes processing when a log containing defect information is acquired by the mobile terminal 100 set by the log mode. The defects include defects caused by the order of the operation, and/or defects from disablement caused by functions being executed at the same time.

Generation control is conducted by rotating and using multiple log files included in the storage device 206. The size of each log file has maximum limit. When the amount of information written in a log file exceeds the maximum limit, information stored in the oldest generation of log file is erased or discarded. New information is written in the log file whose information has been erased or discarded. In the flow chart illustrated in FIG. 6, generation control of two log files, namely log file A 2062 and log file B 2064, is conducted.

When new information is written into a log file, the mobile terminal 100 determines whether log information including defect information is included in the log file to be erased or discarded. If log information including defect information is included in the log file to be erased or discarded, the log information including the defect information is stored in the defect information present log file 2082 of the storage device 208 by the storage device 208.

Operation of the mobile terminal 100 is conducted by the user (step S602).

Log information is outputted (step S604). Specifically, information concerning access requests is outputted as a log in response to access requests between the operating system and the hardware resources. For example, information about a request from the key driver 210 to access the device controller 2222, information about a request from the touch panel driver 214 to access the device controller 2222, information about a request from the application 230ₙ to access the file system controller 2224, and information about a request from the log service 228 to access the file system controller 2224 is outputted. The information concerning the access requests is written into a log file of the storage device 206 by the flash driver 218. For example, the information is written in the log file A 2062.

The log information may include a date, a time, a driver name, a message, and the like. Specifically, the message may include information indicating key codes or information indicating screen coordinates.

For example, the information expressed below in (1) may be outputted to the flash driver 218 from the key driver 210.

2010/01/07,12:55:09,KYD,press and hold key[0x1F] (1)

In the above (1), “KYD” indicates the driver name and “press and hold key[0x1F]” represents the message.

For example, the information expressed below in (2) may be outputted to the flash driver 218 from the touch panel driver 214.

2010/01/07,12:55:09,TPD,tap panel[x:120 y:150] (2)

In the above (2), “TPD” indicates the driver name and “tap panel[x:120 y:150]” represents the message.

The mobile terminal 100 determines whether the size of the log file A 2062 is the maximum size or less (step S606). Specifically, the file system controller 2224 determines whether the total amount of log information stored in the log file A 2062 is equal to or lower than the maximum capacity of the log file A 2062.

If it is determined that the log file A 2062 size exceeds the maximum limit (step S606: NO), the mobile terminal 100 determines whether log information including defect information is included in the log information stored in the log file A 2062 (step S608). Specifically, the file system controller 2224 refers to the log file A 2062 stored in the storage device 206 to determine whether the log information including defect information is included.

When it is determined that the log information including defect information is included in the log file A 2062 (step S608: YES), the mobile terminal 100 stores the log file A 2062 in the defect information present log file 2082 (step S610). Specifically, the file system controller 2224 notifies the flash driver 218 that the size of the log file A 2062 exceeds the maximum limit and that defect information is included in the log file A 2062 when it is determined that log information including defect information is included in the log file A 2062. The processing to store the log file A 2062 in the defect information present log file 2082 stored in the storage device 208 is conducted between the flash driver 218 and the flash driver 220. The log information including the defect information or all the information stored in the log file A 2062 may be stored in the defect information present log file 2082.

When it is determined that the log information including the defect information is not included in the log file A 2062 (step S608: NO), or when the log information stored in the log file A 2062 is stored in the defect information present log file 2082 (step S610), the mobile terminal 100 erases the log information stored in the log file B 2064 (step S612). Specifically, the file system controller 2224 erases the log information stored in the log file B 2064 stored in the storage device 206.

The mobile terminal 100 saves the log information included in the log file A 2062 as the log file B 2064 (step S614).

The mobile terminal 100 creates a new log file A 2062 (step S616).

When it is determined that the size of the log file A 2062 is equal to or less than the maximum size in step S606 (step S606: YES), or when the log file A 2062 is established as the file for storing the log information in step S616, the mobile terminal 100 writes the log information into the log file A 2062 (step S618). Specifically, the file system controller 2224 writes, as log information, information indicating pressed key codes from the trace mode key driver 212, information indicating touched position coordinates from the trace mode touch panel driver 216, and information from the application layer and the service/middle layer from the file system controller 2224.

Returning to step S602, the same processing is conducted according to operations by the user and the like.

<Mobile Terminal Operations (3)>

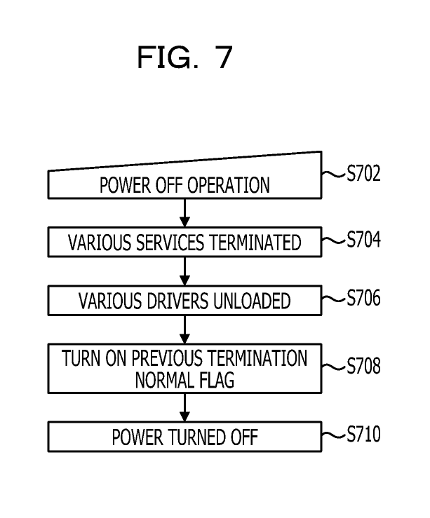

FIG. 7 illustrates processing in which an operation is conducted to turn the power of the mobile terminal 100 OFF.

An operation to turn OFF the power of the mobile terminal 100 is conducted (step S702).

The mobile terminal 100 terminates various services (step S704).

The mobile terminal 100 unloads various drivers (step S706).

The mobile terminal 100 turns the previous termination normal flag 2084 ON if the operations of the mobile terminal 100 are terminated normally (step S708). Specifically, the drivers instruct the flash driver 220 to turn ON the previous termination normal flag 2084 to be stored in the storage device 208 if the operations are terminated normally.

The power of the mobile terminal 100 is turned off (step S710).

According to the present embodiment, if the operations are not terminated normally in the previous termination, or based on an operation by the user, log information is accumulated as needed. As a result, desired logs can be collected without increasing the memory capacity. By using the logs collected by the mobile terminal 100, defects can be analyzed and efficiency in finding the cause can be improved.

### Second Embodiment

### Mobile Terminal

The hardware configuration of the mobile terminal 100 is substantially the same as the mobile terminal illustrated in FIG. 1.

<Mobile Terminal Functions>

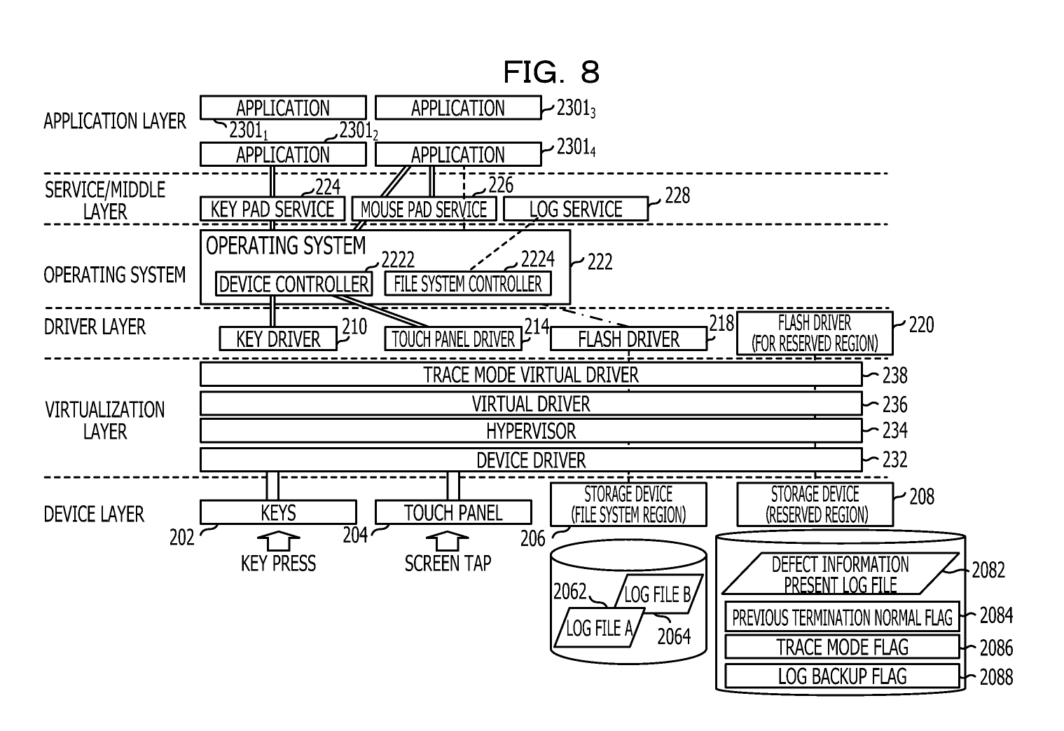

FIG. 8 illustrates an embodiment of the mobile terminal 100. FIG. 8 mainly illustrates a software configuration.

The mobile terminal 100 illustrated in FIG. 8 is depicted by the device layer, a virtualization layer, the driver layer, the operating system, the service/middle layer, and the application layer.

The operating system, the service/middle layer, and the application layer are substantially the same as the operating system, the service/middle layer, and the application layer illustrated in FIG. 2.

A virtual environment is achieved in the mobile terminal 100. Upon activation of a loader, a device driver 232 is initialized, and a trace mode virtual driver 238 is activated in the virtual environment when the log mode is set. The trace mode virtual driver 238 outputs information indicating the codes of pressed keys to the flash driver 218. Additionally, the trace mode virtual driver 238 outputs information indicating coordinates of touched positions to the flash driver 218.

Furthermore, the mobile terminal 100 activates a hypervisor 234. The hypervisor 234 activates a driver corresponding to a device operated by the user. Specifically, the hypervisor 234 activates the key driver 210 when the keys 202 are operated by the user. The hypervisor 234 also activates the touch panel driver 214 when the touch panel 204 is operated by the user.

<Mobile Terminal Functions>

The operations of the mobile terminal 100 are substantially the same as those illustrated in FIGS. 3, 6, and 7.

<Mobile Terminal Activation Processing Details>

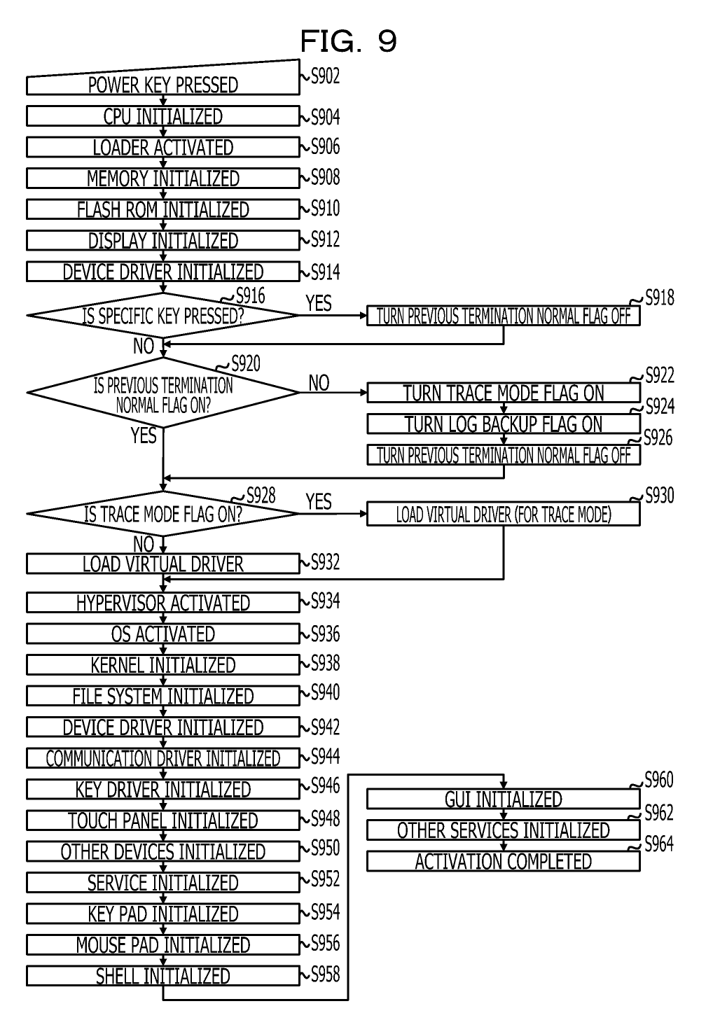

FIG. 9 is a flow chart illustrating detailed processing for activating the mobile terminal 100.

The power key of the mobile terminal 100 is pressed (step S902).

The mobile terminal 100 initializes the CPU 102 (step S904).

The mobile terminal 100 activates the loader (step S906).

The mobile terminal 100 initializes the memory (step S908). Specifically, the loader initializes the memory.

The mobile terminal 100 initializes the flash ROM (step S910). Specifically, the loader initializes the flash ROM.

The mobile terminal 100 initializes the display (step S912). Specifically, the loader initializes the display.

The mobile terminal 100 initializes the device driver 232 (step S914). Specifically, the loader initializes the device driver.

The mobile terminal 100 determines whether a specific key was pressed (step S916). Specifically, the device driver 232 determines whether the specific key of the keys 202 was pressed. The loader may also determine whether the specific key of the keys 202 was pressed.

If it is determined that the specific key is pressed (step S916: YES), the mobile terminal 100 turns the previous termination normal flag 2084 OFF (step S918). Specifically, the device driver 232 turns the previous termination normal flag 2084 in the storage device 208 OFF when it is determined that the specific key among the keys 202 was pressed. The loader may also turn the previous termination normal flag 2084 in the storage device 208 OFF when it is determined that the specific key among the keys 202 was pressed.

If it is determined that the specific key was not pressed in step S916 (step S916: NO), or when the previous termination normal flag 2084 is turned OFF in step S918, the mobile terminal 100 determines whether the previous termination normal flag 2084 is ON (step S920). Specifically, the device driver 232 determines whether the previous termination normal flag 2084 is ON. Whether the previous termination normal flag 2084 is ON or not may also be determined by the loader.

When it is determined that the previous termination normal flag 2084 is not ON (step S920: NO), the mobile terminal 100 turns the trace mode flag 2086 ON (step S922). Specifically, the device driver 232 turns the trace mode flag 2086 ON. The trace mode flag 2086 may also be turned ON by the loader.

Additionally, the mobile terminal 100 turns the log backup flag 2088 ON (step S924). Specifically, the device driver 232 turns the log backup flag 2088 ON. The log backup flag 2088 may also be turned ON by the loader.

Additionally, the mobile terminal 100 turns the previous termination normal flag 2084 OFF (step S926). Specifically, the device driver 232 turns the previous termination normal flag 2084 OFF. The previous termination normal flag 2084 may also be turned OFF by the loader.

When the previous termination normal flag 2084 is determined to be ON (step S920: YES), or when the previous termination normal flag 2084 is turned OFF in step S926, the mobile terminal 100 determines whether the trace mode flag 2086 is ON (step S928). Specifically, the device driver 232 determines whether the trace mode flag 2086 is ON. The loader may also determine whether the trace mode flag 2086 is ON.

When it is determined that the trace mode flag 2086 is ON (step S928: YES), the mobile terminal 100 loads the trace mode virtual driver 238 (step S930). Specifically, the device driver 232 loads the trace mode virtual driver 238 when it is determined that the trace mode flag 2086 is ON. The trace mode virtual driver 238 may be loaded by the loader when it is determined that the trace mode flag 2086 is ON.

When it is determined that the trace mode flag 2086 is OFF (step S928: NO), the mobile terminal 100 loads a virtual driver 236 (step S932). Specifically, the device driver 232 loads the virtual driver 236 when it is determined that the trace mode flag 2086 is OFF. The virtual driver 236 may be loaded by the loader when it is determined that the trace mode flag 2086 is OFF.

When the trace mode virtual driver 238 is loaded in step S930, or when the virtual driver 236 is loaded in step S932, the mobile terminal 100 activates the hypervisor (step S934). Specifically, the device driver 232 activates the hypervisor. The hypervisor may be activated by the loader.

The mobile terminal 100 activates the OS 222 (step S936).

The kernel is initialized (step S938). Specifically, the device controller 2222 of the OS 222 initializes the kernel.

The file system is initialized (step S940). Specifically, the device controller 2222 of the OS 222 initializes the file system.

A device driver is initialized (step S942). Specifically, the device controller 2222 of the OS 222 initializes the device driver.

A communication driver is initialized (step S944). Specifically, the device controller 2222 of the OS 222 initializes the communication driver.

The key driver 210 is initialized (step S946). Specifically, the device controller 2222 of the OS 222 initializes the key driver 210.

The touch panel 204 is initialized (step S948). Specifically, the device controller 2222 of the OS 222 initializes the touch panel 204.

The other devices are initialized (step S950). Specifically, the device controller 2222 of the OS 222 initializes the other devices.

The mobile terminal initializes a service (step S952).

The key pad is initialized (step S954).

The mouse pad is initialized (step S956).

The shell is initialized (step S958).

The GUI is initialized (step S960).

The other services are initialized (step S962).

The activation processing is completed (step S964).

According to the present embodiment, if the operations are not terminated normally in the previous termination, or based on an operation by the user, log information is accumulated as needed. As a result, desired logs are collected without increasing the memory capacity. By using the logs collected by the mobile terminal 100, defects can be analyzed and efficiency in finding the cause can be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. An information processing apparatus executing a program module under control of an operating system, the apparatus comprising:
a log mode setting unit that sets a log mode that is an operating state for collecting information related to an operation in the information processing apparatus;
a log mode control unit that, during an activation process of the operating system, loads a log output module that is a program module for outputting, as a log, information related to an access request between the operating system and a hardware resource when the access request is generated, if the log mode is set in the information processing apparatus when the operating system is activated; and
a log collecting unit that collects the information related to the access request as the log according to the log output module.

2. The information processing apparatus according to claim 1, further comprising:
an operation history storing unit that stores an operation history indicating that the information processing apparatus is switched to a dormant state based on a normal series of operations upon the information processing apparatus being caused to switch to the dormant state;
wherein,
the log mode unit sets the log mode in the information processing apparatus if the operation history is not stored in the operation history storing unit.

3. The information processing apparatus according to claim 2, further comprising:
an operation history initializing unit that invalidates the operation history to be stored in the operation history storing unit according to a certain operation by a user;
wherein,
the log mode unit sets the log mode in the information processing apparatus if the operation history to be invalidated by the operation history initializing unit is not stored in the operation history storing unit.

4. The information processing apparatus according to claim 1, further comprising:
a storage unit that stores
a first program module for causing the operating system or the hardware resource to execute a command in response to the command between the operating system and the hardware resource; and
a second program module for causing operation information related to an access request between the operating system and the hardware resource to be outputted as a log when the command is caused to be executed by the first program module;
wherein,
when the log mode is set in the information processing apparatus, the log mode control unit loads the second program module when the first program module to be loaded upon activation of the operating system is initialized.

5. The information processing apparatus according to claim 1, further comprising:
a storage unit that stores
a first program module for causing the operating system or the hardware resource to execute a command according to the command between the operating system and the hardware resource; and
a second program module for causing operation information related to an access request between the operating system and the hardware resource to be outputted as a log when the command is caused to be executed by the first program module;
wherein,
when the log mode is not set in the information processing apparatus, the log mode control unit unloads the second program module when the second program module to be loaded upon activation of the operating system is initialized.

6. A log output control method executed in an information processing unit that executes a program module under control of an operating system, the method comprising:
loading, when the operating system is activated, a log output module that is a program module that outputs, as a log, information related to an access request between the operating system and a hardware resource when the access request is generated, when a log mode that is an operating state to collect information related to an operation is set in the information processing apparatus; and
outputting the information related to the access request according to the loaded log output module.

7. The information processing apparatus according to claim 1, wherein
the log mode setting unit sets the log mode in the information processing apparatus when an abnormality in a recent operation in the information processing apparatus is detected.

8. The information processing apparatus according to claim 1, wherein
the log mode setting unit sets the log mode in the information processing apparatus according to a certain operation by a user.

9. The information processing apparatus according to claim 1, wherein
a device driver is included in the log output module.

10. The information processing apparatus according to claim 1, wherein
a virtual driver is included in the log output module.

11. A portable terminal apparatus that executes a program module under control of an operating system, the apparatus comprising:
a state determining unit that determines whether or not a state exists to switch to a log mode that is an operating state for collecting information related to an operation to the corresponding device; and
a log mode control unit that, when it is determined that the state to switch the log mode exists, causes a log output module that is a program module having a command to output, to a log, information related to an access request between the operating system and a hardware resource when the access request is generated, to be loaded during activation processing of the operating system.
